(19) United States
(12) Patent Application Publication
(10) Pub. No.: US 2007/0038523 A1
(43) Pub. Date: Feb. 15, 2007

(54) System and method for transactional hedging

(75) Inventors: Ofer Komem, Ramat Gan (IL); Geoffrey David Klein, Tel Aviv (IL); Gideon Argov, Kadima (IL); Gil Sarig, Herzlia (IL); Benny Peer, Herzlia (IL)

Correspondence Address: SULLIVAN & WORCESTER LLP, ONE POST OFFICE SQUARE, BOSTON, MA, 02109, US

(73) Assignee: E4X Inc., New York, NY (US)

(21) Appl. No.: 11/434,550

(22) Filed: May 15, 2006

Related U.S. Application Data
(63) Continuation-in-part of application No. 11/082,762, filed on Mar. 18, 2005.
Application No. 11/082,762 is a division of application No. 09/597,461, filed on Jun. 19, 2000, now Pat. No. 6,892,184.

(51) Int. Cl. G06Q 30/00

(52) U.S. Cl. 705/26

(57) ABSTRACT

A system and a method for supporting e-commerce and card present transactions in multiple currencies, in which the local currency of the purchaser is different from the local currency of the vendor, such that the exchange between the currencies is hedged at the time of sale of the product. The system and method enable the purchaser to receive a final price for the product before the transaction is performed. The system and method also provide a mechanism for the actual exchange between the currencies of the purchaser and of the vendor, such that the aspects of the transaction regarding payment are fully supported. Preferably, transactional hedging of the currency transactions is performed, in order to reduce the risk involved with predetermination of prices. The system and method optionally and preferably provide end-to-end management of the rates through hedging, such that a single exchange rate (or set of exchange rates in a predefined relationship) preferably apply throughout a linked set of transactions, optionally also for payments that are separated in time. The system and method optionally and preferably support a vendor selling a package of products made up of elements from different suppliers, each supplier having a price for the product element in a separate supplier currency. The supplier currencies are different from purchaser and vendor currencies; preferably the suppliers are paid at different times. The system preferably hedges all transactions such that suppliers, vendor and purchaser are not exposed to currency fluctuations and that multiple currency rates are hedged for the transaction from time of booking until payments to suppliers and vendors

### RELATIONSHIP TO EXISTING APPLICATIONS

The present application is a Continuation in Part of U.S. Divisional patent application Ser. No. 11/082,762, filed on Mar. 18, 2005, the contents of which are hereby incorporated by reference. The above mentioned U.S. Divisional patent application claims priority from U.S. patent application Ser. No. 09/597,461 filed on Jun. 19, 2000, now U.S. Pat. No. 6,892,184, issued on May 10, 2005.

### FIELD OF THE INVENTION

The present invention relates to a system and a method for transactions in a plurality of currencies, and in particular, to such a system and method which enable a price of a product to be accurately determined in the plurality of currencies before the transaction is performed, or “hedged”, through forecasting of a plurality of interconnected transactions.

### BACKGROUND OF THE INVENTION

The Internet has enabled computer users all over the world to interact and communicate electronically. One particularly popular mode for communication is through Web pages, which collectively form the World Wide Web. Web pages are useful for displaying text and graphics, and even animation, video data and audio data. Unsurprisingly, Web pages have also become popular for electronic commerce (e-commerce), as they enable vendors to display various types of goods to users, and to effectively advertise these goods. A large number of Web sites are currently devoted to e-commerce, and users can purchase a wide range of goods, from books to electronic equipment and even perishable goods, such as groceries.

Part of the attraction to producing a Web site for e-commerce is that international sales of products are possible. Computer users can view and purchase products without being in the physical “bricks and mortar” store of the vendor, and even without being in the same geographical area. However, although the Internet and the World Wide Web have easily crossed international boundaries for communication, e-commerce is still hampered by the requirement for payment in the currency of a particular country. Typically, a vendor must be paid in the currency of the vendor's own country, which may be different from that of the purchaser.

The problem has been at least partially solved through credit cards which can be used for purchases internationally. Such credit cards enable a purchaser to purchase goods through e-commerce from a vendor in a different country. However, although credit card companies handle currency transactions from the currency of the purchaser to the currency of the vendor, thereby enabling multiple currency e-commerce transactions to occur, the final cost may vary widely. For example, credit card companies may use a conversion rate which is less favorable to the user, than if the user had performed the currency transaction through a bank or other financial institution. In other cases, e-commerce Web sites which attempt to provide information concerning the final cost of their goods in a variety of currencies may find that changes in the currency market have caused their prices to be inaccurate, thereby exposing the vendors or purchasers to currency risks, regardless of the actions of the credit card companies.

In addition, vendors who wish to support transactions in multiple currencies, regardless of the risk, must also handle complex accounting issues in these multiple currencies.

A more useful solution to this problem would enable the purchaser to purchase goods with currency which is local to the purchaser, at a price which is known to the purchaser in advance, through e-commerce Web sites that are targeted at international buyers. This solution would enable the purchaser to examine goods from the Web site of choice, and then to view information concerning the final cost of these goods in the purchaser's own currency, regardless of the currency of vendor. In addition, such a solution would enable the vendor to handle transactions with only a single currency, thereby minimizing risk and simplifying accounting issues, while still enabling the purchasers to use the currency of choice for purchases. Unfortunately, such a solution is not currently available.

In a B2B (business to business) scenario, a different set of problems may arise with regard to currency transactions. In this scenario, the purchaser may negotiate to purchase goods from the seller through the Internet, such as through a Web site, or through other means. The purchaser guarantees payment to the seller for the goods via a payment mechanism. There are several payment mechanisms available to guarantee large amount transfers between business trading partners, including Letter of Credit, Swift, ACH and others. Transactional hedging mechanisms which would support these types of transactions at the point of 'sale”, or business transaction, would also be useful, but unfortunately are not available.

In addition, many complicated financial transactions are performed on a daily basis between multiple commercial entities in order to provide goods or services on an international basis. Such transactions are typically and preferably performed through computer networks such as the Internet, and may involve both commercial organizations in B2B transactions and also private individuals (consumers). These transactions are becoming increasingly automated, yet various aspects of the transactions are still performed manually, without seamless integration, thereby increasing the cost and complexity of the transactions. Transactional hedging mechanisms would support automation of the cross-currency aspects of these transactions.

### SUMMARY OF THE INVENTION

There is an unmet need for, and it would be highly useful to have, a system and a method for multiple currency transactions for e-commerce, whether from a business to a consumer or between businesses, in which the final price of the product is given to the purchaser in the local currency of the purchaser before a purchase is made, and such that a final price is also guaranteed to the seller in the local currency of the seller, through hedging of the currency transaction on behalf of the seller by a transactional hedging service.

There is also an unmet need for, and it would be highly useful to have, a system and a method for multiple currency transactions for e-commerce, which would provide automated support and integrated flow for the currency transactions, preferably including automated transactional hedging of currency exchanges.

According to an additional teaching there is also provided, a method for supporting a transaction for purchasing a product by a purchaser from a plurality of suppliers through a vendor, the product having a price, the local currency of the purchaser being different from a plurality of local currencies of a plurality of suppliers, the method comprising: (a) purchasing a plurality of products from a plurality of suppliers by the purchaser through the vendor, each supplier being paid in a separate local currency of the supplier; (b) determining exchange rates between the currency of the purchaser and a plurality of supplier currencies, each of the exchange rates being hedged and being guaranteed for a separate predetermined period of time; (c) converting the price of the product from each supplier local currency to the local currency of the purchaser to form a final price according to the exchange rate, such that the purchaser receives information concerning the final price before a payment transaction is performed; (d) receiving payment from the purchaser for the final price to perform the payment transaction; (e) converting the payment from the local currency of the purchaser to the local currency of each supplier to form a converted payment according to the exchange rate, wherein the exchange rate is guaranteed at a time of calculating the final price for the purchaser, such that the price in the local currency of each supplier is guaranteed and such that the price in the local currency of the purchaser is guaranteed, and is hedged; and (f) paying the suppliers with the converted payment.

According to preferred embodiments of the present invention, there is provided a method for supporting a transaction flow between a purchaser, a vendor and a supplier for an item, the item having a supplier price, the purchaser having a purchaser currency, the vendor having a vendor currency and the supplier having a supplier currency comprising: providing rate information for converting between the vendor, purchaser and supplier currencies, comprising hedging of the vendor, purchaser and supplier currencies such that the amount to be paid to each of the vendor and supplier is fixed according to the rate information; calculating a purchaser price for the purchaser according to the rate information and the supplier price; receiving payment from the purchaser according to the purchaser price; paying the vendor in the vendor currency; and paying the supplier in the supplier currency by the vendor; wherein an exchange rate between each of the vendor, purchaser and supplier currencies is fixed from the calculating the purchaser price, such that a value of the transaction is fixed.

Preferably the vendor receives a vendor fee and wherein the calculating the purchaser price comprises also including the vendor fee.

Also preferably, there is a delay between the receiving the payment from the purchaser and the paying the supplier, the delay being hedged in the rate information. Also preferably, the receiving the payment from the purchaser is performed by a credit card company, such that the paying the vendor is performed by the credit card company in settlement.

Preferably, the receiving the payment from the purchaser and the paying the supplier are performed with a time delay of at least one week. More preferably, the time delay is of at least one month. Most preferably, the item comprises at least one of a rental car, a hotel room or a seat on an airline flight. Also most preferably, the item comprises the hotel room.

According to preferred embodiments of the present invention, there is provided a method for supporting a transaction flow between a purchaser, a vendor and a supplier for an item, the item having a supplier price, the purchaser having a purchaser currency, the vendor having a vendor currency and the supplier having a supplier currency comprising: providing rate information for converting between the vendor, purchaser and supplier currencies, comprising hedging of the vendor, purchaser and supplier currencies such that the amount to be paid to each of the vendor and supplier is fixed according to the rate information; calculating a vendor fee for the vendor according to the rate information; calculating a purchaser price for the purchaser according to the rate information, the vendor fee and the supplier price; receiving payment from the purchaser according to the purchaser price; paying the vendor fee in the vendor currency; and paying the supplier in the supplier currency; wherein an exchange rate between each of the vendor, purchaser and supplier currencies is fixed from the calculating the purchaser price, such that a value of the transaction is fixed.

Preferably, the receiving payment from the purchaser comprises: receiving the payment by a third party, the third party performing the hedging and calculating the rate information; such that the paying the vendor fee and paying the supplier are performed separately by the third party. Alternatively, the receiving payment from the purchaser comprises: receiving the payment by a third party; paying the vendor all of the payment by the third party; and returning a portion of the payment to the third party by the vendor for paying the supplier. More preferably, the receiving the payment from the purchaser and the paying the supplier are performed with a time delay of at least one week. Most preferably, the time delay is of at least one month. Also most preferably, the item comprises at least one of a rental car, a hotel room or a seat on an airline flight. Most preferably, the item comprises the hotel room.

Optionally, the providing the rate information further comprises: calculating a value of the transaction according to a functional currency of the vendor; wherein the value of the transaction remains constant from the calculating the purchase price through the paying the supplier.

According to still other preferred embodiments of the present invention, there is provided a method for supporting a transaction for purchasing a product by a purchaser from a vendor, the purchaser using an account having an account number, the product having a price, the currency used by the purchaser being different from a local currency of the vendor, the transaction being processed over an electronic network, the method comprising: determining a currency of the purchaser through use of an identifying element within data exchanged with the purchaser, determining an exchange rate of the local currency of the vendor to the currency of the purchaser; converting the price of the product from the local currency of the vendor to the currency of the purchaser to form a final price according to the exchange rate; receiving payment from the purchaser for the final price to perform the payment transaction; converting the payment from the currency of the purchaser to the local currency of the vendor to form a converted payment according to the exchange rate, wherein the exchange rate is guaranteed at a time of transaction, such that the price in the local currency of the vendor is guaranteed and such that the price in the currency of the purchaser is guaranteed, and is hedged; and paying the vendor with the converted payment wherein at least the receiving the payment from the purchaser, the converting the payment and the paying the vendor are hedged by a transactional hedging system, such that a risk of a change in the exchange rate is hedged.

Preferably, the purchaser and vendor communicate through an electronic network. Alternatively, the purchaser and vendor are physically in the same location. Also alternatively, the identifying element comprises leading digits of the account number of the purchaser. More preferably, the account number is associated with a credit card. Alternatively, the identifying element is indicative of a geographical region associated with a currency. Most preferably, the geographical region is determined through leading digits of a credit card.

Alternatively the transactional hedging system manages the risk of the change in the exchange rate and guarantees the exchange rate throughout the transaction.

According to yet other preferred embodiments of the present invention, there is provided a method for supporting a transaction for purchasing a product by at least one purchaser from a plurality of suppliers through a vendor, the product having a price, the local currency of the purchaser being different from a plurality of local currencies of a plurality of suppliers, the method comprising; purchasing a plurality of products from a plurality of suppliers by the purchaser through the vendor, each supplier being paid in a separate local currency of the supplier; determining exchange rates between the currency of the purchaser and a plurality of supplier currencies, each of the exchange rates being hedged and being guaranteed for a separate predetermined period of time; converting the price of the product from each supplier local currency to the local currency of the purchaser to form a final price according to the exchange rate, such that the purchaser receives information concerning the final price before a payment transaction is performed; receiving payment from the purchaser for the final price to perform the payment transaction; converting the payment from the local currency of the purchaser to the local currency of each supplier to form a converted payment according to the exchange rate, wherein the exchange rate is guaranteed at a time of calculating the final price for the purchaser, such that the price in the local currency of each supplier is guaranteed and such that the price in the local currency of the purchaser is guaranteed, and is hedged; and paying the suppliers with the converted payment.

Preferably, the product is comprised of a package of products and services from a plurality of suppliers.

Alternatively, the vendor does not hold the product in inventory, such that the supplier delivers the product and is due to be paid only upon purchase by the purchaser. More preferably, the method further comprises: transferring access to the product by the vendor to the purchaser. Most preferably, the transferring access to the product is performed before the paying the suppliers. Also most preferably, the product is a hotel room.

According to still preferred embodiments of the present invention, there is provided a system for supporting a transaction flow for an item in a plurality of currencies, comprising: (a) a supplier for supplying the item according to a supplier price, the supplier price being in a supplier currency; (b) a purchaser for purchasing the item according to a purchaser price, the purchaser price being in a purchaser currency, the purchaser providing payment in the purchaser currency; (c) a vendor for selling the item to the purchaser, the vendor adding a vendor fee, the vendor fee being in a vendor currency, such that the purchaser price is determined according to the supplier price, the vendor fee and rate information for converting between the supplier currency, the purchaser currency and the vendor currency; and (d) a transactional hedging service for controlling transaction flow between the supplier, the purchaser and the vendor, the transactional hedging service comprising a hedging system for hedging conversions between the supplier currency, the purchaser currency and the vendor currency to determine the rate information, the transactional hedging service providing the rate information to the vendor and the transactional hedging service dividing the payment from the purchaser between the supplier and the vendor.

Preferably, a plurality of suppliers having a plurality of supplier prices and supplier currencies provide the product sold to the purchaser.

Alternatively, the system further comprises a tax authority, wherein the transactional hedging service provides a portion of the payment from the purchaser to the tax authority.

According to preferred embodiments of the present invention, there is provided a method for supporting a transaction flow between a purchaser, a vendor and a supplier for an item, the item having a supplier price, the purchaser having a purchaser currency, the vendor having a vendor currency and the supplier having a supplier currency, the method comprising: providing rate information for converting between the vendor, purchaser and supplier currencies, the information including hedging of an exchange rate between the vendor, purchaser and supplier currencies such that the amount to be paid to each of the vendor and supplier is fixed according to the rate information and such that the exchange rate for the amount to be paid to each of the vendor and supplier and the amount to be paid by the purchaser is hedged to guarantee a future exchange of currency using the exchange rate; calculating a vendor fee for the vendor according to the rate information; calculating a purchaser price for the purchaser according to the rate information, the vendor fee and the supplier price; receiving payment from the purchaser according to the purchaser price by a transactional hedging service; paying the payment to the vendor in the vendor currency by the transactional hedging service, including the vendor fee; paying at least the supplier price to the transactional hedging service by the vendor after a time delay in the vendor currency; and paying the supplier in the supplier currency by the transactional hedging service.

Preferably, the purchaser price is guaranteed for the purchaser for a fixed period of time.

Optionally, the item comprises at least one of a hotel, a rental car and an airline flight. Optionally, the purchase price further comprises a fee for the transactional hedging service. Preferably, the rate information comprises a spot rate, the vendor fee and the transactional hedging service fee for determining the purchase price.

Optionally, the hedging is performed with at least one of an option or a forward contract.

Optionally, the purchaser, the vendor, the supplier and the transactional hedging service communicate on-line. Preferably, the transactional hedging service controls the transaction flow between the purchaser, the vendor and the supplier. More preferably, the transaction flow is automated.

According to preferred embodiments of the present invention, there is provided a system for supporting a transaction flow for an item in a plurality of currencies, comprising: (a) a supplier for supplying the item according to a supplier price, the supplier price being in a supplier currency; (b) a purchaser for purchasing the item according to a purchaser price, the purchaser price being in a purchaser currency, the purchaser providing payment in the purchaser currency; (c) a vendor for selling the item to the purchaser, the vendor adding a vendor fee, the vendor fee being in a vendor currency, such that the purchaser price is determined according to the supplier price, the vendor fee and rate information for converting between the supplier currency, the purchaser currency and the vendor currency, the vendor comprising a vendor accounting system; and (d) a transactional hedging service for controlling the transaction flow between the supplier, the purchaser and the vendor, the transactional hedging service comprising a hedging system for hedging conversions between the supplier currency, the purchaser currency and the vendor currency to determine the rate information, the transactional hedging service providing the rate information to the vendor and the transactional hedging service dividing the payment from the purchaser between the supplier and the vendor, wherein the transactional hedging service provides information about the transactional flow to the vendor accounting system and wherein a value of the transactional flow remains constant in the vendor currency.

According to preferred embodiments of the present invention, there is provided a system for supporting a transaction flow for a plurality of items in a plurality of currencies, comprising: (a) a plurality of suppliers for supplying the item according to a plurality of supplier prices, each supplier price being in a supplier currency, each supplier currency being different for each supplier; (b) a purchaser for purchasing the plurality of items according to a plurality of purchaser prices, the purchaser prices being in a purchaser currency, the purchaser providing payment in the purchaser currency, the purchaser currency being different from at least two of the supplier currencies; (c) a vendor for selling the item to the purchaser, the vendor adding a vendor fee, the vendor fee being in a vendor currency, such that the purchaser prices are determined according to the supplier prices, the vendor fee and rate information for converting between the supplier currencies, the purchaser currency and the vendor currency, the vendor comprising a vendor accounting system; and (d) a transactional hedging service for controlling the transaction flow between the suppliers, the purchaser and the vendor, the transactional hedging service comprising a hedging system for hedging conversions between the supplier currencies, the purchaser currency and the vendor currency, the transactional hedging service providing the rate information to the vendor and the transactional hedging service dividing the payment from the purchaser between the suppliers and the vendor, wherein the transactional hedging service provides information about the transactional flow to the vendor accounting system and wherein a value of the transactional flow remains constant in the vendor currency.

According to other preferred embodiments of the present invention, there is provided a method for supporting a transaction flow between a purchaser, a vendor and a supplier for an item, the item having a supplier price, the purchaser having a purchaser currency, the vendor having a vendor currency and the supplier having a supplier currency, the method comprising: providing rate information for converting between the vendor, purchaser and supplier currencies, the information including hedging of an exchange rate between the vendor, purchaser and supplier currencies such that the amount to be paid to each of the vendor and supplier is fixed according to the rate information and such that the exchange rate for the amount to be paid to each of the vendor and supplier and the amount to be paid by the purchaser is hedged to guarantee a future exchange of currency using the exchange rate; calculating a vendor fee for the vendor according to the rate information; calculating a purchaser price for the purchaser according to the rate information, the vendor fee and the supplier price; receiving payment from the purchaser according to the purchaser price by a transactional hedging service; paying the payment to the vendor in the vendor currency by the transactional hedging service, including the vendor fee; paying at least the supplier price to the transactional hedging service by the vendor after a time delay in the vendor currency; and paying the supplier in the supplier currency by the transactional hedging service; wherein the transaction is reversed before any of the paying the vendor, the transactional hedging service or the supplier, such that at least one of the paying the vendor, the transactional hedging service or the supplier is not performed and wherein a reversal of the transaction is hedged such that the purchaser receives a complete amount of the payment in the purchaser currency. Preferably, the reversal comprises a refund, a chargeback or-a cancellation of a credit card payment transaction.

Unless otherwise defined, all technical and scientific terms used herein have the same meaning as commonly understood by one of ordinary skill in the art to which this invention belongs. The materials, methods, and examples provided herein are illustrative only and not intended to be limiting. Implementation of the method and system of the present invention involves performing or completing certain selected tasks or stages manually, automatically, or a combination thereof. Moreover, according to actual instrumentation and equipment of preferred embodiments of the method and system of the present invention, several selected stages could be implemented by hardware or by software on any operating system of any firmware or a combination thereof. For example, as hardware, selected stages of the invention could be implemented as a chip or a circuit. As software, selected stages of the invention could be implemented as a plurality of software instructions being executed by a computer using any suitable operating system. In any case, selected stages of the method and system of the invention could be described as being performed by a data processor, such as a computing platform for executing a plurality of instructions.

Although the present invention is described with regard to a “computer” on a “computer network”, it should be noted that optionally any device featuring a data processor and/or the ability to execute one or more instructions may be described as a computer, including but not limited to a PC (personal computer), a server, a minicomputer, a cellular telephone, a smart phone, a PDA (personal data assistant), a pager, TV decoder, game console, digital music player, ATM (machine for dispensing cash), POS credit card terminal (point of sale), electronic cash register. Any two or more of such devices in communication with each other, and/or any computer in communication with any other computer, may optionally comprise a “computer network”.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a schematic block diagram of a background art process;

FIG. 2 is a schematic block diagram of an exemplary system and process according to the present invention;

FIG. 3 is a schematic block diagram of certain components of FIG. 2 in greater detail;

FIG. 4 is a flowchart of an illustrative method according to the present invention;

FIG. 5 is a detailed implementation of the hedging system of FIG. 3 according to the present invention.

FIG. 6 illustrates a schematic block diagram according to a preferred embodiment of the present invention wherein the transaction between purchaser and vendor preferably takes place remotely (for example online).

FIG. 7 illustrates a schematic block diagram according to a preferred embodiment of the present invention wherein the transaction takes place between a purchaser and a vendor located at the same physical location.

FIG. 8 shows a schematic block diagram according to an exemplary, illustrative and preferred embodiment of the present invention for hedging payments involving a vendor between a purchaser and multiple suppliers.

FIG. 9A shows the operation of vendor 806 and transactional hedging service 808 in more detail, according to preferred but optional embodiments of the present invention.

FIG. 9B shows transactional hedging service 808 in more detail according to preferred embodiments of the present invention.

FIG. 10A shows an exemplary flow chart of a method according to the present invention for transaction handling with hedging.

FIG. 10B shows only the financial aspects of the transaction of FIG. 10A in more detail.

### DESCRIPTION OF THE PREFERRED EMBODIMENTS

The present invention is of a system and a method for supporting commerce transactions involving multiple currencies, preferably for supporting end-to-end transactions with a fixed set of exchange rates, such that the value of the transaction in a particular currency remains fixed. The system and method convert the price of a product from the local currency of a vendor to the local currency of a purchaser, and from the local currency of a supplier to the local currency of the vendor, when the currency of the vendor differs from that of the purchaser and from that of the supplier. The purchaser then receives the final price of the product in the local currency of the purchaser, preferably including any transaction costs which may be incurred as a result of the currency exchange.

The vendor also receives a guarantee for the final amount of payment which is to be received in the local currency of the vendor, and also receives a guarantee of the amount to be paid to the supplier. Preferably, the guaranteed exchange rate is provided for a predetermined period of time. Also preferably, the purchaser and/or the vendor and/or the supplier are charged a fee for performing such a guaranteed exchange, for example by incorporating such a fee into the rate which is used to calculate the final price given to the purchaser. Thus, hedging is provided for the entire transaction from end-to-end (from supplier to vendor to purchaser), which has not been previously provided in the art.

Once the purchaser decides to purchase the product, the financial payment details of the purchaser are sent to a particular payment mechanism. The mechanism receives the amount of payment in the local currency of the purchaser from the purchaser. The payment is converted to the local currency of the vendor according to the system of the present invention, which may optionally be completely separate from the payment mechanism which receives payment from the purchaser. The vendor then receives payment in the local currency of the vendor and makes payment in the local currency of the supplier. Preferably, a plurality of transactions are combined for the stage of conversion, rather than buying and selling currencies separately for each transaction.

According to a preferred embodiment of the present invention, the payment from the purchaser may optionally be split into different portions, such that each portion is paid to a different entity at a different time. For example, the vendor may optionally receive the entire payment, but is then required to pay a part of the payment to a supplier at a later time. This portion of the payment is preferably hedged separately, in order for the entire transaction to be maintained at the same value in the functional currency of the vendor.

According to another preferred embodiment of the present invention, the vendor may optionally pay a plurality of suppliers of products in a plurality of local currencies of the suppliers, while in turn accepting payment from a plurality ofpurchasers in a plurality of local currencies of the purchasers. In this case, multiple exchange rates are set, including at least a first exchange rate for paying at least one supplier by the vendor and at least a second exchange rate for paying the vendor by at least one purchaser. Each of the first and the second exchange rates is therefore guaranteed for a separate predetermined period of time. One example of such a vendor is a travel agent who wishes to sell hotel rooms. The hotel typically wishes to receive payment in the local currency, while a customer would want to pay for the hotel room in another, potentially different local currency. The present invention enables the vendor to apply transactional hedging at the point of sale, so that the vendor is protected from currency risks on transactions with both suppliers and purchasers.

Alternatively in a currency transaction involving exchanging more than two currencies, the hedging system may determine a single exchange rate based on the supplier requested by a particular purchaser. As a non-limiting, illustrative embodiment of the present invention, a travel agent (vendor), who books rooms in a foreign hotel's currency (supplier), may optionally quote the price to a traveler (purchaser) in a different currency than that of either the vendor or of the supplier. The travel agent wishes to receive at least part of the payment in the local currency of the travel agent, while the purchaser wishes to purchase the hotel room using a different currency and the hotel wishes to receive payment in yet a third currency (typically each party wishes to be paid and/or to pay in that party's local currency, although optionally the party may use any preferred currency). The price quoted by the vendor to the purchaser would be in the purchaser's currency and not the vendor's own local currency, yet would be based on the price in the supplier's preferred currency. All of these different currency exchanges (supplier to vendor and vendor to purchaser currency) are preferably hedged, thereby preventing each party from risking a change in the exchange rate (and hence paying or receiving more or less than originally determined at the time of reservation of the hotel room).

This embodiment may optionally eliminate the need for two exchange rates in a three way transaction, that between purchaser and vendor and that between vendor and supplier. As previously described, this embodiment supports end-to-end transactions between the purchaser, vendor and supplier, such that a defined set of exchange rates are provided at the start of the transaction and are maintained throughout the transaction, such that the transaction preferably has a constant value, more preferably in the functional currency of the vendor. In other words, the transaction is preferably exchange rate neutral irrespective of when the parties make or receive the actual payments.

Furthermore, optionally and preferably the vendor may estimate the vendor's cost for the transaction more accurately, including the effect of hedging the exchange rates, and consequently the vendor can provide more competitive prices for his services.

Preferably, risk management is provided for the currency transactions, through international currency trading, in order to minimize any loss which may occur as a result of fluctuations in the exchange rates. The present invention is thus able to advantageously use the currency conversion with bulk transactions for both greater efficiency and to lower the costs of such currency exchanges.

According to optional but preferred embodiments of the present invention, the full transactional process for the end-to-end transaction may optionally feature a transaction reversal, such as a cancellation, refund or chargeback (the latter is typically associated with credit cards, in which the purchaser may dispute a particular charge and may require that the credit card issuing authority refund the amount of the charge in question). The present invention enables the purchaser to receive a refund without any loss being incurred by any party to the transaction, as the amount received from the purchaser is fully hedged and remains exchange rate neutral throughout the transactional process.

According to other preferred embodiments of the present invention, the transactions are at least partially integrated into the vendor's business processes, and are preferably at least partially performed automatically. More preferably, the transactions are completely integrated and are also more preferably completely automatic. As an illustrative, non-limiting example of such integration, the purchaser of a good or service decides to make a selection of one or more goods or services for such a purchase, preferably through a computer network such as the Internet and/or through cellular telephones or any other communication network. The purchaser is given information by a vendor's system regarding the purchase price in whichever currency is desired by the purchaser; optionally, such a currency may be the local currency of the purchaser and is optionally and preferably detected automatically, for example as described herein.

The vendor is preferably acting as an intermediary between the purchaser and a supplier. The supplier wishes to receive payment in a currency that is different from that of the purchaser, and preferably also that is different from that preferred by the vendor. Therefore, the present invention preferably features hedging of the purchase price between the currency of the purchaser and that of the supplier (to cover the cost of the good(s) and/or service(s), as well as that of the vendor (to cover the cost of the vendor's operation and the profit thereof). Optionally and preferably, the purchase price may be split and each portion (of the vendor and of the supplier) hedged separately. Alternatively, the entire amount may be hedged in the currency of the vendor, with a separate amount hedged to pay the supplier later.

According to preferred embodiments of the present invention, the flow of the transaction between the purchaser, the vendor and the supplier is at least partially automated. As a non-limiting illustrative example, the purchaser may pay by credit card, after which the vendor receives the payment. The payment to the vendor is then preferably automatically divided so as to give a portion to the supplier, which preferably receives it automatically (for example through a one-time credit card number, as described in greater detail below, and/or through a bank wire). More preferably, all of these transactions are hedged through a hedging system which receives information about all of these transactions, and which is therefore able to hedge them automatically, such that end-to-end transaction flow and also the fixed exchange rate relationships are provided automatically. Most preferably, an audit module receives information about all of these transactions, in order to be able to automatically provide audit information about the flow of these transactions and the transaction history.

The present invention preferably also provides for security and verification mechanisms, in order to ensure that vendors receive the proper payment, and that the correct currency exchange rates are used for calculating the prices and for effecting payment to the vendors.

According to a particular preferred implementation of the present invention, there is provided software components and services to enable multi-currency e-commerce, allowing vendors to conduct their operations in a single currency while accepting payments in multiple currencies from purchasers and making payments in multiple currencies to suppliers. The transactional hedging service is responsible for hedging transactions against currency fluctuations, thereby ensuring that the vendor receives complete payment for goods in the local currency of the vendor. Thus, vendors are assured that the expected prices which are established for goods match funds received in their bank accounts, through hedging of the transaction at the point of sale, while purchasers are able to determine the final price for a product in the local currency of the purchaser at the time of sale.

With the trend towards expanded on-line international trading activity, ease of use, cost effectiveness and immediacy become top priorities. The online point-of-sale hedging and transaction exchange services of the present invention reduce complexity of international e-commerce transactions. The present invention supports clean auditable accounting; by outsourcing the currency management to a third party, it simplifies meeting FASB reporting requirements for hedging.

Furthermore, the described solution of the present invention is independent of applied payment mechanisms, and does not assume liabilities for financial settlements or delivery of products. These liabilities remain with the banks, credit card companies and shipping companies, as they do in a non-Internet and/or non e-commerce environment.

The principles and operation of the present invention may be better understood with reference to the drawings and the accompanying description.

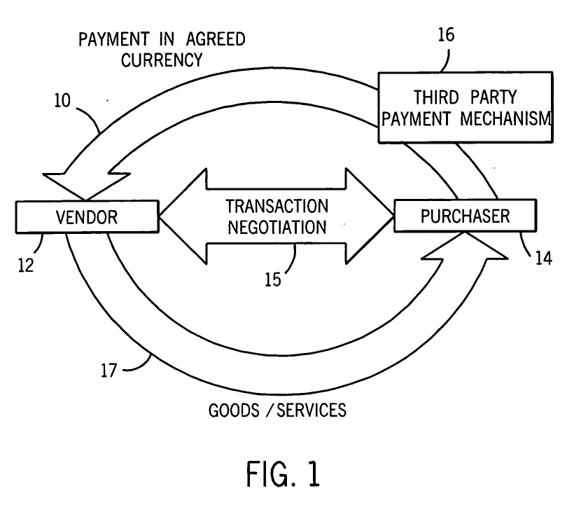

Referring now to the drawings, FIG. 1 is a schematic block diagram of a background art process for a typical single currency online transaction, as such a transaction is currently performed according to the background art.

In a typical online transaction 10 involving an online payment, a vendor 12 and a purchaser 14 negotiate online to exchange goods or services for payment, through a transaction negotiation 15. By “online”, it is meant that communication is performed through an electronic communication medium, including but not limited to, telephone voice communication through the PSTN (public switched telephone network), cellular telephones or a combination thereof; exchanging information through Web pages according to HTTP (HyperText Transfer Protocol) or any other protocol for communication with and through mark-up language documents; exchanging messages through e-mail (electronic mail), messaging services such as ICQ™ for example, and any other type of messaging service; any type of communication using a computational device as previously defined; as well as any other type of communication which incorporates an electronic medium for transmission.

Vendor 12 agrees to deliver goods or services to purchaser 14, who in turn contracts to pay a negotiated amount in a negotiated currency to vendor 12 in exchange for the product(s) (goods and/or services).

As shown in FIG. 1, typically, a third party payment mechanism 16 enables the transaction to occur, by providing varying degrees of assurance for the flow of payment from purchaser 14 to vendor 12. Such a service is particularly useful for transactions when purchaser 14 and vendor 12 are physically separated, as for example in e-commerce transactions. Third party payment mechanism 16 allows vendor 12 to ship good(s) and/or provide service(s) (shown as arrow 17) prior to settlement of cash in the bank. Various types of third party payment clearance services exist, providing different degrees of assurance for the ultimate flow and deposition of funds, as well as different settlement periods for delivery of funds.

Third party payment mechanism 16 acts as a bridge between the “virtual” Internet world and the “real” financial world, and as previously described, is currently used for e-commerce transactions. Illustrative, non-limiting examples of third party payment clearance services 16 include credit card networks and associated acquirers and processors which are related to these credit card networks.

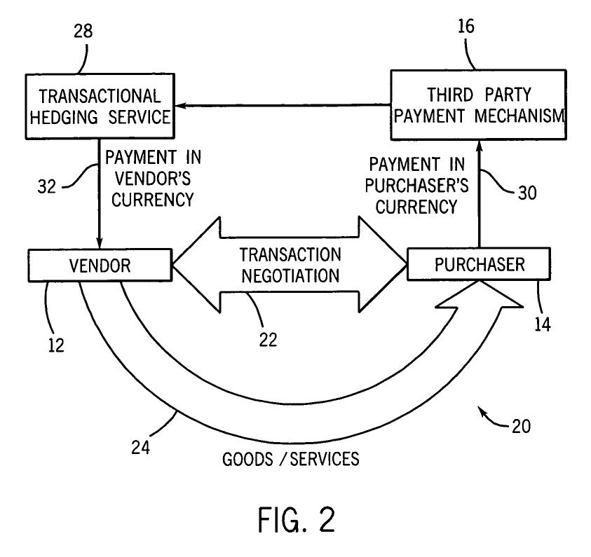

As shown in FIG. 2, the process according to the present invention for supporting e-commerce transactions involving multiple currencies can optionally be implemented with the third party payment mechanism, although this mechanism is not required, as the present invention does not rely upon the use and/or provision of such a clearance service; if online payment mechanisms become available in the future which do not require a third party to guarantee the transfer of funds, the present invention could also optionally be used with such online payment mechanisms. Examples of various types of online payment mechanisms include, but are not limited to, e-money cards and accounts, credit cards, and micropayment mechanisms of various types.

The schematic block diagram shows the flow through an exemplary system 20 for providing a guaranteed price to both purchaser 14 and vendor 12 in their respective local currencies through transactional hedging at the point of sale, supported through the direct exchange of funds, preferably by including the process of risk management for the actual conversion of the funds. As for FIG. 1, purchaser 14 and vendor 12 engage in an online transaction, with a transaction negotiation flow 22 for the actual purchase of the product, whether goods or services. Again, purchaser 14 receives the product through a product exchange flow (shown as “goods/services”) 24 after the process of fund transfer has occurred, or at least has been guaranteed to occur such that vendor 12 is satisfied.

Unlike FIG. 1, however, system 20 provides currency hedging through a transactional hedging service 28 which is inserted between a process for receiving payment 30 from purchaser 14, and a process for effecting payment 32 to vendor 12.

Transactional hedging service 28 determines the actual amount of payment required from purchaser 14, in order to pay the requested amount to vendor 12 in the local currency of vendor 12. Preferably, transactional hedging service 28 combines a plurality of such transactions, in order to more effectively exchange currencies through the international currency exchange market, optionally and more preferably with risk management. Thus, transactional hedging service 28 receives the price from vendor 12, determines the appropriate exchange rate from the local currency of vendor 12 to the local currency of purchaser 14, and then provides the price to purchaser 14, while also guaranteeing that vendor 12 will receive the full payment in the local currency of vendor 12 at a future settlement date. This entire process can also be described as transactional hedging at the point of sale.

If purchaser 14 decides to purchase the product, then the amount of payment is determined according to these previously defined prices. The solution protects vendor 12 and purchaser 14 from currency fluctuations occurring between the time of price negotiation and the time of payment settlement. Since a plurality of such transactions are preferably aggregated, the aggregated positions can optionally be managed for risk in the inter-bank market by applying standard risk management strategies, previously available for large transaction amounts only.

The solution of system 20 is widely applicable for transactional hedging for all types of online and off-line multi-currency trading interactions, regardless of the size of the transaction, regardless of the relationship between parties (business-to-business, business-to-consumer, consumer-to-consumer) and regardless of the mechanism which is used to assure payment. Although third party payment mechanism 16 may be involved as shown, such a service is an optional component of system 20. Also optionally and more preferably, a plurality of third party payment mechanism 16 (not shown) may be involved, such that vendor 12 can optionally receive payment in parallel from several third party payment mechanism 16, which is a preferred feature of the present invention.

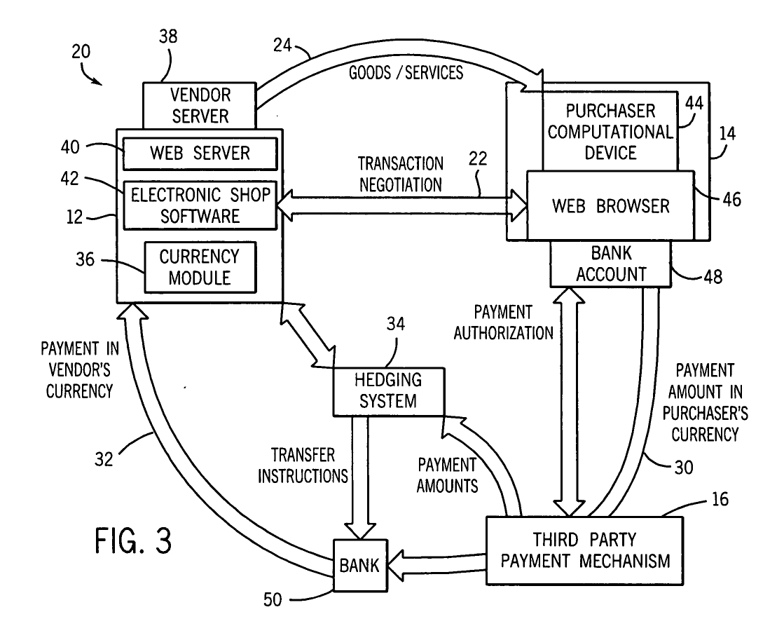

FIG. 3 is a schematic block diagram of a more detailed exemplary implementation of system 20, showing the flow of data and funds through system 20. System 20 preferably features a hedging system 34, which is the core component for distributing currency rates, receiving payment information from vendor 12 and also optionally receiving payment information from third party payment mechanism 16.

With regard to the first function, hedging system 34 sends updated currency rates to a currency module 36 installed at a vendor server 38. The combination of hedging system 34 and currency module 36 is optionally and preferably described as a “transactional hedging service”, as these two components together support and control the process of transactional hedging at the point of sale.

Vendor server 38 may optionally include such functions as a Web server 40, for providing Web pages for e-commerce through Web-based communication; and also electronic shop software module 42, for managing e-commerce, accounting and other functions of vendor 12. Currency module 36 receives the currency exchange rates from hedging system 34, preferably at intervals which are defined by vendor 12, more preferably with a margin supplement as per agreement with vendor 12. The margin supplement is an additional fee, which is optionally added to each transaction, whether directly or indirectly, for example through the determination of the exchange rate. This fee is preferably related to the costs of hedging but also allows the vendor to earn additional revenue from the hedging function by adding a vendor margin supplement. When currency module 36 receives a request from electronic shop software module 42 for a price in a particular local currency for purchaser 14, currency module 36 calculates the price in the local currency of purchaser 14.

As shown for this optional but preferred implementation of system 20 for Web-based communication, purchaser 14 interacts with a purchaser computational device 44, which in turn operates a Web browser 46. Web browser 46 receives Web pages from Web server 40. Each such Web page may optionally include information about the product to be purchased, for example, including the price in the local currency of purchaser 14. For this implementation, the transaction negotiation (shown as arrow 22) between purchaser 14 and vendor 12 occurs through Web-based communication, such that purchaser 14 enters information and/or commands through Web browser 46, and in turn receives information through Web pages from Web server 40.

Preferably, electronic shop software module 42 interacts with currency module 36 in order to receive the price in the local currency of purchaser 14, for displaying this price dynamically on Web pages which are served by Web server 40. Also optionally and preferably, the type of local currency for purchaser 14 is automatically determined by currency module 36 through the use of DNS lookup information or cookies. Purchaser 14 is preferably able to override such an automatic currency detection mechanism by entering the preferred currency manually.

Once purchaser 14 has decided to purchase the product, Web browser 46 is optionally redirected toward third party payment mechanism 16, for a typical payment process in e-commerce transactions. (Note that this is a typical implementation but other implementations are optionally supported whereby for example the interaction with the third party payment mechanism 16 is performed directly by electronic shop software module 42 without requiring redirection to a third party). Third party payment mechanism 16 collects payment credentials from purchaser 14, such as credit card details or other information. Third party payment mechanism 16 may optionally perform an authorization request to a purchaser account 48, which could be a bank account and/or credit card account for example, in order to determine whether funds are available for the purchase. Following authorization, confirmation of the transaction is sent to purchaser 14 and vendor 12. If a plurality of third party payment mechanisms 16 is available, then vendor 12 optionally and preferably is able to select a particular third party payment mechanism 16 for receiving payment from purchaser 14, for example according to the criterion of the amount of fees which are charged by third party payment mechanism 16 and/or according to a payment mechanism or mechanisms that are predominant at the location of purchaser 14. Payment in the currency of purchaser 14 is shown with regard to arrow 30 (“payment amount in purchaser's currency”).

In addition, third party payment mechanism 16 also optionally sends the information about amounts to be settled to hedging system 34. Alternatively or additionally, currency module 36 can also send such information to hedging system 34. Such information is preferably dynamically aggregated by hedging system 34 with information collected from other vendors.

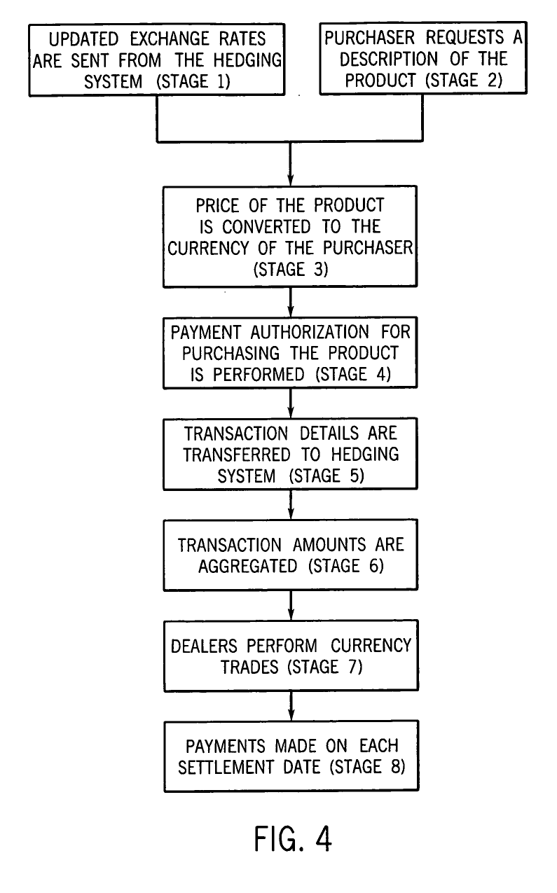

Foreign currency positions in each of the currencies for each settlement date are monitored by the operator of hedging system 34, as described in greater detail with regard to FIG. 4 below. Associated currency dealers preferably manage the risks exposed by these positions using various risk management strategies, according to forecasting of volumes based on historical data prior to sending rates, resulting in the execution of forward and options deals in the interbank market.

On the settlement date for at least one transaction, and preferably for a plurality of transactions, the actual payment is optionally and preferably sent to a bank 50, in the currency of each purchaser 14, for example from third party payment mechanism 16. Preferably simultaneously, hedging system 34 provides instructions for transferring amounts for these transactions in the currencies expected by each vendor 12 from bank 50 to the bank account of each vendor 12. Payment in the currency of vendor 12 is shown with regard to arrow 32 (“payment in vendor's currency”).

FIG. 4 is a flowchart of an exemplary but preferred method for performing the transaction of FIGS. 2 and 3, according to the present invention.

As shown, in stage 1, the updated exchange rates are sent from the hedging system which is managing the currency exchanges to the server of the vendor. For example, in FIG. 3, the hedging system sent this information to the currency module on the vendor server. The exchange rate may optionally reflect a transaction or margin fee, in addition to the exchange rates which are available through the FOREX markets.

In stage 2, the purchaser requests a description of the product through online communication, for example through the Web browser of the purchaser computational device as explained in FIG. 3. In stage 3, the price of the product is converted to the currency of the purchaser, and is preferably displayed to the purchaser, for example through a Web page.

In stage 4, optionally payment authorization for purchasing the product is performed through a third party payment enabling mechanism, in the local currency of the purchaser.

In stage 5, transaction details, including the amount of the transaction in the currencies of the purchaser and the vendor, are transferred to the hedging system. These transaction details are used for the purposes of hedging the currency exchanges and effecting settlement of the payment transactions in the currency of the vendor.

In stage 6, preferably transaction amounts in the local currencies of the purchaser and the vendor are aggregated, more preferably according to type of currency and payment delivery date (settlement due date).

In stage 7, dealers who are associated with the hedging system perform currency trades in order to assure that currency is available to meet the required settlements on the settlement due date(s). The amount of each such settlement is determined for each vendor, in the local currency of the vendor, according to a rate which is set in stage 1. Thus, the amount of the transaction is fixed, yet the currency market may cause the exchange rate to fluctuate, such that the dealers are preferably able to mitigate any risk associated with such fluctuations by combining or aggregating transactions for hedging the aggregated positions.

Optionally and more preferably, stage 7 is performed automatically, for example by software programs which monitor forecasted and actual positions held in each currency as well as the overall market behavior, in order to effect trades at the most advantageous moment for minimizing risk. In addition, also more preferably, risk is managed by guaranteeing a particular exchange rate for a limited period of time, such that the settlement date must fall within the time period for which hedging is guaranteed.

In stage 8, on each settlement date, payments to the trading parties, such as the vendors, are delivered in the local currency of each party.

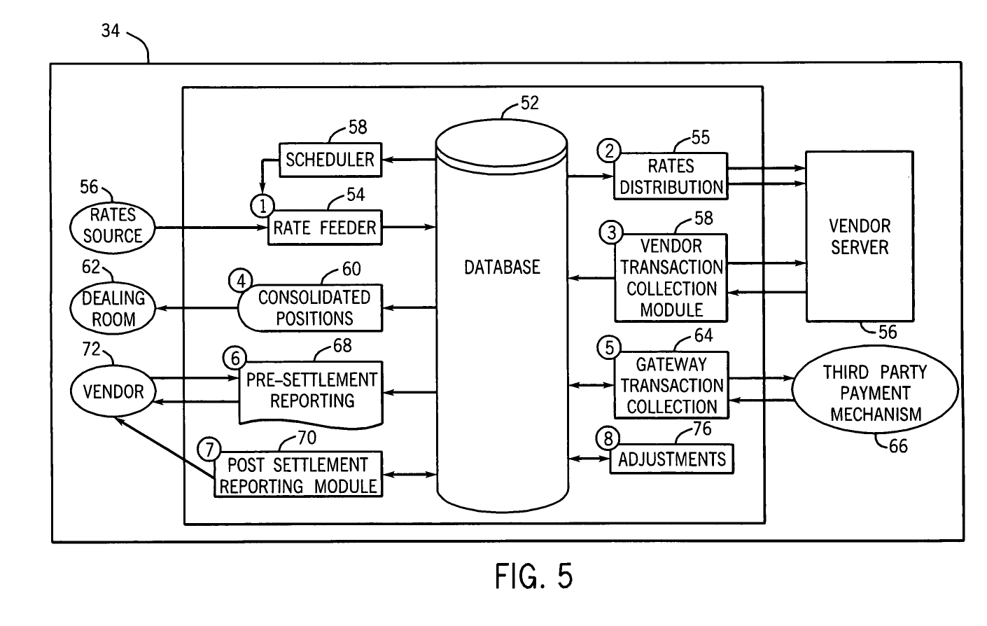

FIG. 5 is a schematic block diagram of an exemplary but preferred embodiment of hedging system 34 of FIG. 3, showing the components of hedging system 34 and their interaction with various other entities.

The other entities which are separate from hedging system 34 are shown only as general blocks, rather than with the specific technological features which would enable them to communicate with hedging system 34, as such technological features are well known in the art and could easily be implemented by one of ordinary skill in the art.

As shown, hedging system 34 preferably features a central database 52 for storing such information as the exchange rates, identification information for vendors, transaction information, and information about other parties involved in the transactions, such as third party payment mechanisms for example.

In a first process, a rate feeder 54 receives currency exchange rate information from a rate source 56, such as the FOREX markets, including but not limited to Reuters or Telerate currency rate service for example. Optionally, rate feeder 54 receives such information periodically, according to a scheduler 58. The rate information is posted to central database 52.

Next, the rates, optionally including a markup, are distributed from central database 52 to a rate distribution module 55, and thence to vendor server 56 which contains the currency module of FIG. 3, as previously described with regard to FIG. 3. In turn, vendor transaction information is received from vendor server 56 by a vendor transaction collection module 58. The transaction information is posted to central database 52.

Central database 52 also provides information about aggregated positions, preferably with regard to a plurality of transactions, to a consolidated positions module 60, which in turn is accessed by a dealing “room” 62, managed by the transactional hedging service, for actually performing risk management on the transaction operations. Information concerning the outcome of such operations is also preferably stored in central database 52. Dealing “room” 62 may optionally be implemented manually, with one or more human dealers, but is preferably implemented automatically, with a software program for performing the trades; the trades themselves may optionally be performed as described below.

A gateway transaction collection module 64 receives information about collected funds from third party payment mechanism 66, and transfers this information to central database 52. Reports, both before and after settlement of the payment, are optionally and more preferably provided by a pre-settlement reporting module 68 and a post-settlement reporting module 70, respectively. This information may optionally be provided to vendors 72, for example. Any required adjustments between amounts collected from vendor 72 and transaction amounts reported by gateway 64 are preferably performed through an adjustment module 76.

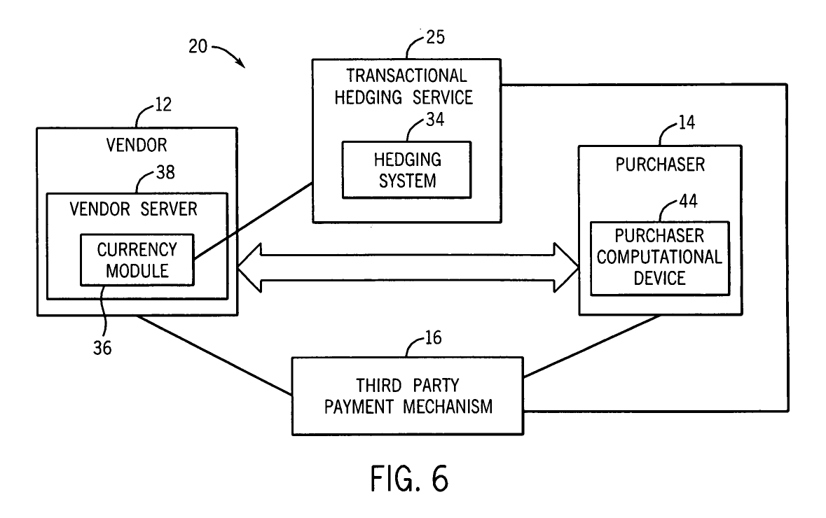

FIG. 6 is a schematic block diagram of an exemplary implementation of system 20 for e-commerce transactions, showing the flow of information and funds through system 20, in which payment is preferably effected through a credit card.

As shown, system 20 has been simplified to focus on payment with a credit card;

optionally, the components not shown from FIG. 3 could also be implemented with system 20 of FIG. 6. System 20 preferably features a hedging system 34, installed at a transactional hedging service 25, whereby hedging system 34 distributes currency rates to a currency module 36 installed at vendor server 38.

Hedging system 34 receives payment information from vendor server 38 and optionally from third party payment mechanism 16.

As stated above, currency module 36 receives the rate exchange information from hedging system 34. Vendor 12 may define intervals to receive currency rate information from hedging system 34 at a transactional hedging service 25 and additionally may optionally determine a margin supplement to be added thereto. The margin supplement is an additional fee, which is optionally added to each transaction, whether directly or indirectly, for example through the determination of the exchange rate.

As shown, purchaser 14 interacts with a purchaser computational device 44, which in turn communicates with vendor server 38 (for example through Web pages, as described with regard to FIG. 3).

Preferably, currency module 36 determines the price in the local currency of purchaser 14, for adding this price dynamically to Web pages, for example, or otherwise providing this information to purchaser 14. Also optionally and preferably, the type of local currency for purchaser 14 may automatically be determined by currency module 36 through the mapping of the IP address of purchaser computational device 44 to the relevant country and hence to the relevant local currency (although as noted previously, purchaser 14 may optionally select a different currency for making the purchase). Purchaser 14 is preferably able to override such an automatic currency detection mechanism by entering the preferred currency manually. In the case of IP address mapping, the currency of purchaser computational device 44 is known to vendor 12 immediately upon communication between vendor server 38 and purchaser computational device 44, and thus a price in the purchaser's currency can be displayed.

Once purchaser 14 has decided to purchase the product, purchaser computational device 44 is optionally directed toward third party payment mechanism 16, for a typical payment process in e-commerce transactions. Third party payment mechanism 16 collects payment credentials from purchaser 14, such as credit card details or other information. Alternatively, purchaser 14 may prefer to pay through an alternative payment method, such as a Paypal account or direct bank transfer or other online payment system. Third party payment mechanism 16 may optionally perform an authorization request to a purchaser account, which could be a bank account and/or credit card account for example, in order to determine whether funds are available for the purchase. Vendor server 38 may optionally perform the collection of payment credentials directly from purchaser 14 without requiring the redirection of purchaser computational device 44 toward third party payment mechanism 16.

In another embodiment of system 20, purchaser 14 may already have an account set up with vendor 12, for example because of a previous purchase. This account information is preferably provided to currency module 36, more preferably regarding an identifying element within information sent by purchaser 12. Optionally this identifying element comprises leading digits of the account number, for example a credit card that is associated with an account number, a Paypal account or other online payment credentials. This may be performed whereby the credit card digits are indicative of a geographical region. In such a case as identification of purchaser currency according to the leading digits within an account number, the local currency of purchaser 14 is known only after purchaser 14 inputs this information to vendor server 38, usually occurring close to the end of the transaction. Therefore, the price of the product or service that purchaser 14 is purchasing cannot be provided to purchaser 14 in the purchaser's local currency until the end of the transaction (at least based upon this information).

Following authorization, confirmation of the transaction is sent to purchaser 14 and vendor 12. If a plurality of third party payment mechanisms 16 is available, then vendor 12 optionally and preferably is able to select a particular third party payment mechanism 16 for receiving payment from purchaser 14, for example according to the criterion of the amount of fees which are charged by third party payment mechanism 16.

In addition, third party payment mechanism 16 also optionally sends the payment information to hedging system 34 at transactional hedging service 25. This optional embodiment permits accurate hedging of the amount(s) involved if money needs to be returned to purchaser 14 and/or if third party payment mechanism 16 deducts a fee from the amount settled. Money may need to be returned under a number of different circumstances, including but not limited to, refund in case of cancellation or non availability of the item purchased and/or a charge-back. A charge-back is typically initiated by purchaser 14 in cases where the item delivered is not satisfactory or is not delivered, or when purchaser 14 disputes the transaction.

If purchaser 14 initiates a chargeback, preferably third party payment mechanism 16 provides the information, although optionally the information is received from vendor 12. Alternatively, when a refund is issued, the information is optionally sent from vendor server 38 to hedging system 34. The payment information is optionally sent to hedging system from both third party payment mechanism 16 and vendor server 38 so that both refunds (initiated by vendor) and chargeback (initiated by the purchaser) can be processed. Such information is preferably dynamically aggregated by hedging system 34 with information collected from a plurality of vendors 12 (not shown).

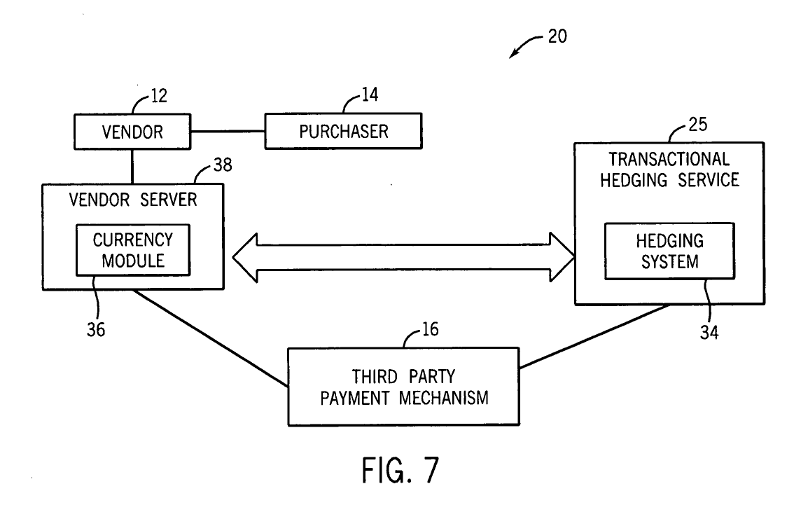

FIG. 7 shows an exemplary “card present” embodiment of system 20, where purchaser 14 utilizing an account in one currency and vendor 12 with different local currency are physically in the same location and the transaction is processed over an electronic network, for example for purchasing through a POS (point of sale). This could preferably occur where purchaser 14 purchases item at vendor 12 where purchaser 14 is outside of purchaser's home country using a credit card associated with a bank in purchaser's home country. In the above implementation, the purchaser's currency may be identified by currency module 36 deployed at vendor server 38, optionally through the use of an identifying element on purchaser's account information, such as the leading digits of purchaser's credit card. This may be performed whereby the credit card digits are indicative of a geographical region.

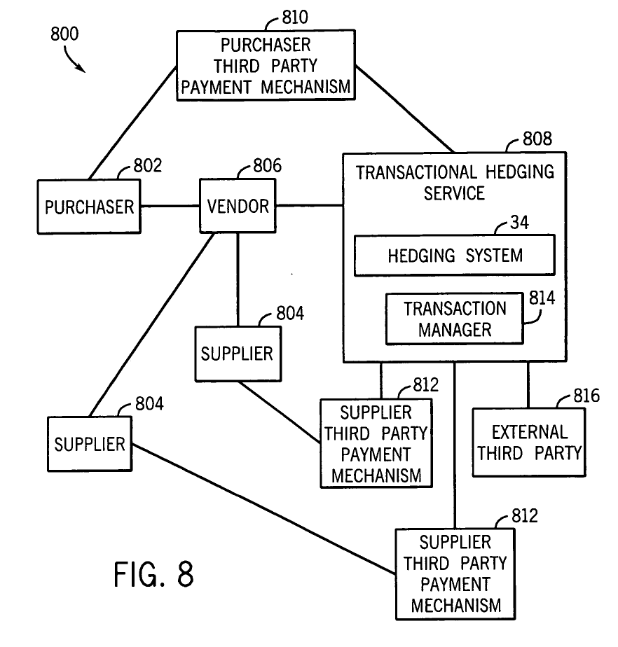

FIG. 8 shows a schematic block diagram according to an exemplary, illustrative and preferred embodiment of the present invention for hedging payments involving a vendor between a purchaser and one or more suppliers. As shown, a system 800 features a purchaser 802 who wishes to purchase one or more good(s) and/or service(s) from one or more suppliers 804 through a vendor 806. For the purpose of clarity, the one or more good(s) and/or service(s) are described herein as an “item” (which may optionally be a plurality of items). Preferably, purchaser 802, vendor 806 and suppliers 804 communicate through computer networks; more preferably, purchaser 802 and vendor 806 communicate “on-line” as previously described.

Vendor 806 preferably receives prices for items from suppliers 804 in supplier currencies, which may optionally be the local currency of supplier 804 or alternatively may be any other currency desired by supplier 804. Vendor 806 communicates the price to purchaser 802 in a purchaser currency, which may optionally be the local currency of purchaser 802 or alternatively may be any other currency desired by purchaser 802. Vendor 806 may optionally allow purchaser 802 to request the desired currency, or alternatively may determine the local currency of purchaser 802 according to the location of purchaser 802, for example according to the IP address of a computer through which purchaser 802 is communicating with vendor 806. Optionally and more preferably, as previously described, purchaser 802 may communicate on-line with vendor 806, for example according to HTTP (for displaying Web pages), although optionally such communication may be performed according to any suitable communication protocol, for example through SMS messages, and/or through a telephone network (for example through voice commands and/or keypad commands and/or voice communication).

In order to be able to hedge the exchange of the respective currencies of purchaser 802 and suppliers 804, vendor 806 preferably receives currency rate information from a transactional hedging service 808. Although transactional hedging service 808 is shown as being separate from vendor 806, transactional hedging service 808 may optionally be integrated with vendor 806. More preferably, vendor 806 wishes to receive a mark-up for assisting in the transaction between purchaser 802 and suppliers 804 in a vendor currency, which is more preferably different from the purchaser currency or the supplier currencies. Therefore, the rate information preferably also enables hedging of the exchange of the vendor currency as well.

Indeed, preferably hedging is provided throughout the transaction flow, from display of price in local currency to purchaser 802 to receipt of payment by vendor 806 and payment to suppliers 804. As this transactional flow preferably features a plurality of currency exchanges, optionally and more preferably with a time delay between at least a first and at least a second exchange, transactional hedging service 808 is preferably able to support end-to-end hedging, such that a fixed set of exchange rate conversion relationships is maintained. As described in greater detail below, such a fixed set of exchange rate relationships also preferably enables the entire transactional flow to be exchange rate neutral with regard to the functional currency of vendor 806, which is the currency in which vendor 806 maintains financial systems, as described in greater detail below.

Hedging is preferably performed by hedging system 34 of transactional hedging service 808, which preferably operates as previously described. Briefly, hedging system 34 determines the rates to be provided to vendor 806. These rates may optionally comprise a mark-up to cover the cost of hedging. Vendor 806 then uses these rates to determine the price of the item in the purchaser currency according to prices in the supplier currencies, and preferably also uses these rates to set the mark-up in the vendor currency; this mark-up is then optionally and preferably added to the price in the purchaser currency to be given to purchaser 802. Alternatively, the mark-up may be charged to supplier 804, in which case the mark-up is determined in the supplier currency. Also alternatively, the mark-up may be split between purchaser 802 and supplier 804, in which case it is determined proportionately in the purchaser and supplier currencies.

Once purchaser 802 has selected the item to be purchased, purchaser 802 provides payment to vendor 806 in the purchaser currency. Preferably from the moment of providing payment, the various amounts of money in the vendor, purchaser and supplier currencies are fixed according to the rate information provided by hedging system 34. Optionally and preferably, payment is made through a purchaser third party payment mechanism 810, which may optionally be a third party payment mechanism 16 as previously described, such as a credit card company, such that payment may optionally comprise providing a credit card number by purchaser 802 to vendor 806. Alternatively any other payment system may be used, such that purchaser third party payment mechanism 810 may optionally be a bank, a micropayment system and/or a payment system such as Paypal, mobile cell phone payment systems or any other such systems that are known in the art.

Purchaser third party payment mechanism 810 then preferably sends the payment to transactional hedging service 808, more preferably in an automatic manner (for example through electronic money transfers) although payment may also optionally be manual. Transactional hedging service 808 preferably pays vendor 806 in the vendor currency, which then transfers at least a portion of the payment to suppliers 804. Optionally and preferably, vendor 806 pays suppliers 804 through transactional hedging service 808 via supplier third party payment mechanism 812. As shown, more preferably vendor 806 sells a plurality of products to purchaser 802 and interacts with a plurality of suppliers 804 and supplier third party payment mechanism 812.

Alternatively, transactional hedging service 808 pays both suppliers 804 (optionally through supplier third party payment mechanism 812) and vendor 806 directly, distributing the payment according to the supplier price and the vendor mark-up. In any case, transactional hedging service 808 may optionally and preferably calculate the split of the payment and hence the amount to be provided as a mark-up, in order to hedge the supplier price and the vendor mark-up separately.

Supplier third party payment mechanism 812 may optionally provide payment to suppliers 804 through any suitable mechanism, which could easily be selected by one of ordinary skill in the art. Preferably, transactional hedging service 808 handles payments to supplier third party payment mechanism 812, although optionally vendor 806 could pay supplier third party payment mechanism 812 directly (not shown). Supplier third party payment mechanism 812 could implement payment by bank wire, ACH, Credit card, or Paypal account for example.

According to other preferred embodiments of the present invention, there may optionally be a significant delay between payment (or at least the initiation of payment) by purchaser 802 and the provision of the item by supplier 804. Such a delay is preferably at least 24 hours, more preferably at least one week and most preferably at least 30 days. Optionally and preferably, the expected delay is determined according to industry norms, such that for example in the travel industry, the typical delay between payment for a hotel room at booking and actual check out from the hotel room is approximately 40 days.

In such a situation, optionally the transaction flow may proceed as follows. Purchaser 802 again provides payment to transactional hedging service 808 through purchaser third party payment mechanism 810. Now transactional hedging service 808 preferably provides the entire amount to vendor 806, which holds the payment until supplier 804 is due to be paid (for example, when the hotel guest checks out of the hotel room).

Vendor 806 then provides to transactional hedging service 808 at least the amount to be paid to supplier 804. Transactional hedging service 808 then optionally and preferably pays supplier 804 (optionally through supplier third party payment mechanism 812 as previously described).

Alternatively, transactional hedging service 808 may only provide the vendor mark-up to vendor 806 in advance of the provision of the item and may retain the amount to be paid to supplier 804. Also alternatively, vendor 806 may pay supplier 804. In any case, hedging in this example is preferably determined according to the projected time of payment to suppliers 804 and vendor 806, such that optionally hedging may be linked to different times of payment for example.

According to other preferred embodiments of the present invention, hedging system 34 includes each mark-up and/or fee that must be paid to an entity in system 800 in the rate information to vendor 806, such that the rate information preferably comprises the spot rate and one or more (more preferably all) mark-ups and/or fees that are to be paid.

According to still other preferred embodiments of the present invention, transactional hedging service 808 performs an overall reconciliation of transaction(s) between vendor 806 and suppliers 804. For example, purchaser 802 may be entitled to a partial or complete refund, if the item cannot be supplied and/or is defective. Such a refund may optionally be performed through a chargeback to a credit card, or optionally through any mechanism involving purchaser third party payment mechanism 810 in which a fee is due to purchaser third party payment mechanism 810. Transactional hedging service 808 preferably reconciles the payments due to vendor 806 and/or suppliers 804 according to such a refund and/or any other fee, ensuring that original exchange rates are applied for calculating amounts that are settled.

Transactional hedging service 808 may optionally be linked to a separate bank or other payment facilitation institution (not shown).

System 800 as described in FIG. 8 has a number of advantages over the background art systems. One exemplary illustrative advantage is the ability to maintain a set of fixed exchange rates through a plurality of transactions between multiple entities as shown in FIG. 8, even if there is a time delay between one or more payments. Maintaining such a set of fixed exchange rates may also optionally be used to support auditing of one or more transactions and/or entities in system 800 and optionally to provide audited reports about such transactions and/or entities. As previously noted, the set of fixed exchange rates enables the entire transaction to retain an exchange rate neutral value in the functional currency of the vendor.

According to still other preferred embodiments of the present invention, transactional hedging service 808 may optionally also provide payment to another entity, such as an external third party 816, which may for example be a tax authority. External third party 816 may require payment related to the purchase from purchaser 802 and/or vendor 806 and/or supplier 804, as in the case of a tax authority. There may optionally be a plurality of external third parties 816 (not shown) to which transactional hedging service 808 may optionally make payment. Optionally and more preferably, if purchaser 802 is a consumer (rather than a business), transactional hedging service 808 preferably makes payment to external third party 816 directly. Transactional hedging service 808 preferably hedges the amount to be paid to external third party 816 according to the currency in which external third party 816 wishes to receive payment; more preferably, a fee for such hedging is included in the rate information provided to vendor 806.

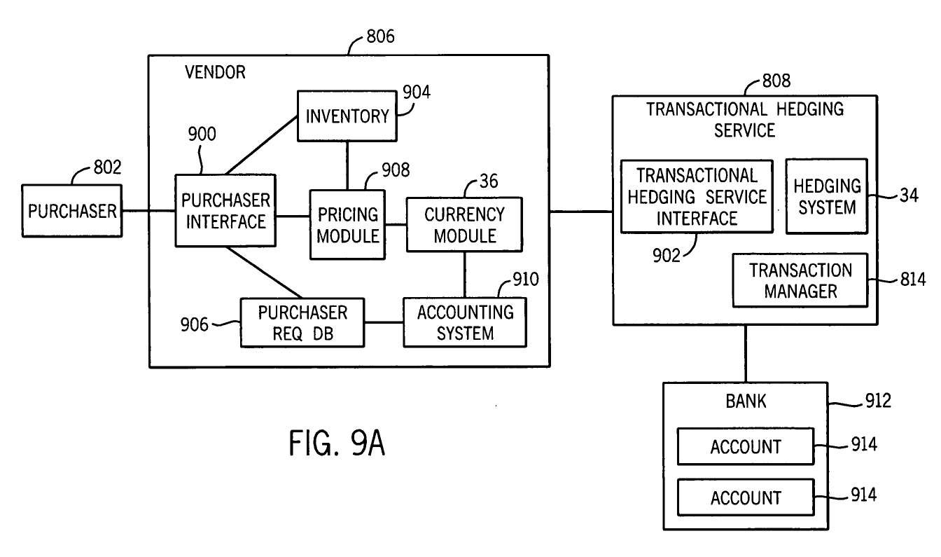

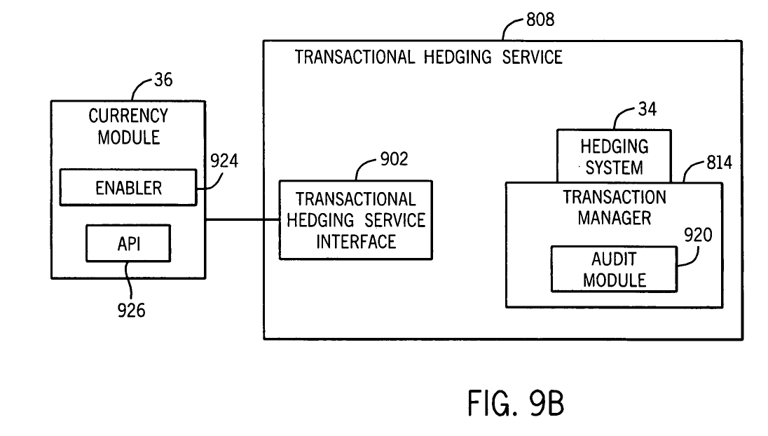

To support such end-to-end rate guarantees and hedging, as shown transactional hedging service 808 preferably handles all aspects of the transactional flow. Transactional hedging service 808 is preferably at least informed by vendor 806 of all aspects of the transaction flow including the split of the amount received from purchaser 802 into separate amounts due in currencies of the vendor, suppliers and/or external third parties. Transactional hedging service 808 optionally and preferably features a transaction manager 814 at transactional hedging service 808. Transaction manager 814 preferably is able to examine the transactions to provide such information as the overall cash flow, a view of all transactions, a specific transaction or a plurality of selected transactions. Furthermore, transaction manager 814 is preferably able to handle reconciliation, consolidation and aggregation, as well as financial reporting, as described in greater detail with regard to FIG. 9.

FIG. 9A shows the operation of vendor 806 and transactional hedging service 808 in more detail, according to preferred but optional embodiments of the present invention. As shown, vendor 806 features a purchaser interface 900 for communication with purchaser 802 and currency module 36 for communication with transactional hedging service 808.

Purchaser interface 900 is preferably in communication with an inventory database 904, which preferably receives information from the supplier (not shown) concerning the availability of an item. Inventory database 904 preferably also includes pricing information from the supplier in supplier local currency. Purchaser interface 900 is also preferably in communication with a purchase request database 906, for storing information about purchaser 802 and the item requested by purchaser 802 for example.

A pricing module 908 is also preferably in communication with purchaser interface 900, for providing prices to purchaser interface 900 according to the purchaser currency. Pricing module 908 preferably receives the supplier price information in the supplier currency from inventory database 904 and the rate information, for converting the price in the supplier currency to the price in the purchaser currency, from transactional hedging service 808. Optionally and more preferably, pricing module 908 communicates with transactional hedging service 808 through currency module 36.

Accounting system 910 may optionally communicate with transactional hedging service 808, for example through transactional hedging service interface 902 for automated delivery of accounting entries to accurately reflect AR (accounts receivable) and AP (accounts payable) activity in multiple currencies. Preferably, this activity is translated into the vendor's functional currency (ie the currency in which accounting system 910 maintains bookkeeping activity) for import into the vendor's financial systems (not shown) which may for example include accounting system 910. A complete reconciled audit trail is optionally and preferably provided for accounting entries by transactional hedging service 808, as described in greater detail below.

Optionally and preferably, transactional hedging service 808 is in communication with a bank 912 or plurality of banks (not shown). Bank 912 preferably features a plurality of accounts 914, more preferably comprising at least one account for each type of currency related to the purchaser currency, the vendor currency, the supplier currency and optionally any other currency; these accounts 914 may optionally be physically located in countries in which currency is received or paid (to reduce the cost of moving funds). Plurality of accounts 914 preferably enables transactional hedging service 808 to aggregate transactions in batch for receiving and/or making payment to various entities, as previously described. Thus, although transaction manager 814 preferably maintains information about each separate transaction, the actual payments are preferably made and/or received in batch mode (with a plurality of payments consolidated).

Transaction manager 814 preferably communicates with bank 912 through a communication interface that is proprietary to bank 912, although optionally any secure system could be used. For example, optionally transaction manager 814 could communicate with bank 912 through a communication interface as described below for communication with currency module 36 in FIG. 9B.

FIG. 9B shows transactional hedging service 808 in more detail according to preferred embodiments of the present invention. As shown, transactional hedging service 808 again features hedging system 34 and transaction manager 814. Transaction manager 814 optionally and preferably features an Audit module 920 for auditing the transactional flows managed by transaction manager 814. Audit module 920 may optionally provide reports according to selected transactions or groups of transactions. Transaction(s) may optionally be selected according to one or more criteria, such as country of purchaser 802 and/or supplier 804, currency in which each transaction is conducted, time of transaction and so forth.

Transactional hedging service 808 preferably communicates through currency module 36 through a transactional hedging service interface 902. Transactional hedging service interface 902 may optionally communicate with currency module 36 through any type of suitable protocols, including but not limited to XML, SQL, and Java. According to an illustrative but non-limiting implementation, the protocol for communication between transactional hedging service interface 902 and currency module 36 preferably features a set of authenticated XML encapsulated service requests exchanged over an HTTP/S connection. The message set supports delivery of currency rates and geo-location data to the vendor (not shown) and collection of transaction data by transactional hedging service 808 as well as maintenance services.

Currency module 36 preferably comprises a set of software applications, documentation and code samples intended to easily be implemented for communication according to the protocol, and preferably supports rapid integration in popular WEB deployment environments on Windows and Unix/Linux platforms. Currency module 36 preferably includes an Enabler 924 and an API (application programming interface) 926.

Enabler 924 is a run-time component, which provides managed persistency of rates and Geolocation data (including but not limited to BIN data that relates to the first 4-6 digits of a credit card number, designating the issuing bank and hence the currency in which the credit card was issued, or tables mapping IP address ranges to currency), and controls transaction flows to transactional hedging service 808. Enabler 924 preferably wraps protocol messages and exchanging data with an ODBC/JDBC compliant database installed at the site, allowing developers to interface with Enabler 924 using standard SQL statements for example, or any other standard protocol, through API 926.

Enabler 924 preferably batches transaction information for transmission to transactional hedging service interface 902. Similarly, transactional hedging service interface 902 preferably batches information to be sent to currency module 36, to avoid reliance on an un-interrupted communication network between them and to ensure fast response time for dynamic price conversion.

According to preferred embodiments of the present invention, communication requests by currency module 36 and access to reporting are authenticated by transactional hedging service 808. Authentication is preferably performed against a pre-assigned username and password, and more preferably also against the IP address of currency module 36 (ie the computational device at which it is installed). Authentication is preferably conducted over the SSL (Secure Socket Layer) protocol. Passwords are more preferably one-way encrypted at transactional hedging service 808.

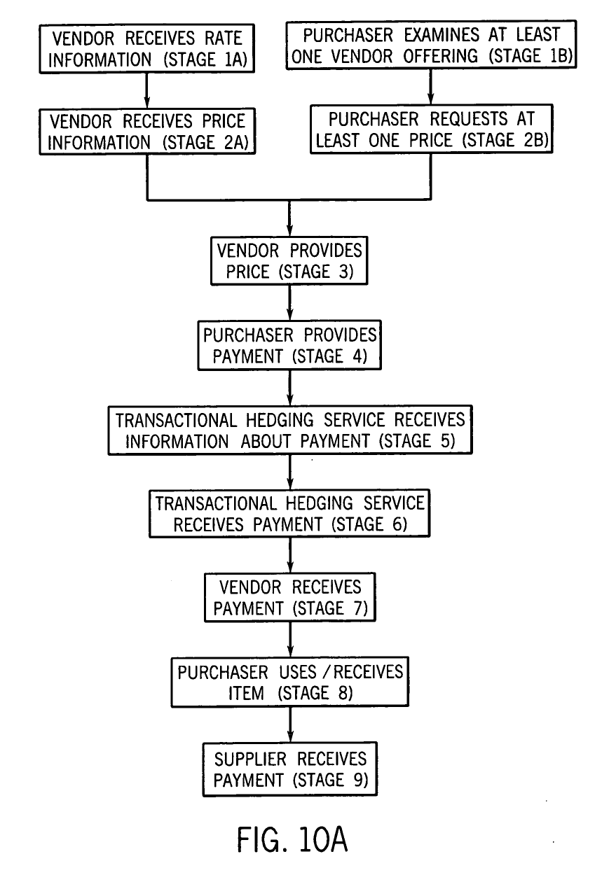

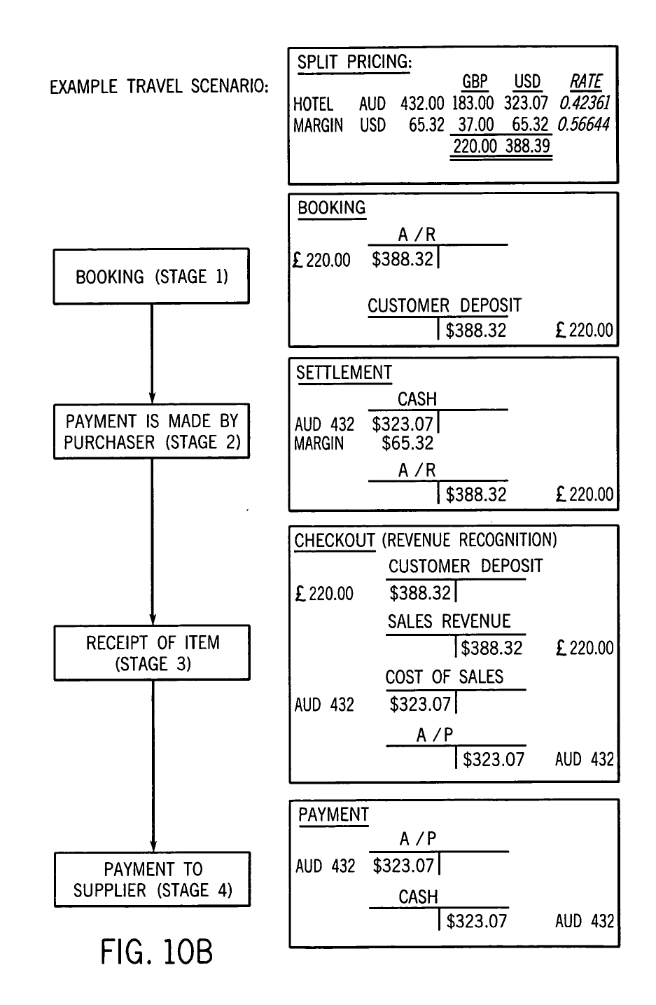

FIG. 10A shows an exemplary flow chart of a method according to the present invention for transactional hedging. As shown, in stage IA, the vendor receives rate information from the transactional hedging service, which preferably comprises the spot price and one or more mark-ups or fees to be added, as previously described. In stage 2A, the vendor receives information about the item(s) that can be supplied from the suppliers, preferably with their price in the supplier currencies. It should be noted that stages 1A and 2A may optionally be performed in any order; further, optionally rate information is provided more frequently than price information, although alternatively the opposite could be true.

In parallel or in sequence, in stage 1B, the purchaser optionally examines at least one vendor offering. In stage 2B, the purchaser requests the price of an offering. It should be noted that optionally the price is provided automatically to the purchaser, such that stage 2B is not required, for example if the vendor can automatically detect the preferred or local currency of the purchaser as previously described.

In stage 3, the vendor provides the price to the purchaser in the purchaser currency, performing the conversion from the supplier currency according to the rate information. This price is preferably guaranteed for at least a period of time to form the purchaser price.

In stage 4, the purchaser provides payment in the purchaser currency according to the purchaser price. Preferably payment is made through a credit card company and/or other third party payment clearance entity.

In stage 5, the transactional hedging service receives information from the vendor and/or third party payment clearance entity regarding the amount of payment and the currency involved.

In stage 6, the transactional hedging service receives payment in the purchaser's currency, preferably from the credit card company and/or other third party clearance entity in a process which is termed “settlement”. In stage 7, the transactional hedging service optionally provides part or all of the payment to the vendor in the vendor's currency.

In stage 8, the purchaser uses and/or receives the item. In stage 9, the supplier is paid for the item in the supplier's currency, optionally by the vendor, but preferably by the transactional hedging service. If all of the payment was provided to the vendor, then the vendor preferably returns the required amount to the transactional hedging service if the supplier is to be paid by the transactional hedging service. The required amount is preferably returned in the vendor's currency the transactional hedging service converts to supplier currency (based on rates delivered at stage 1A) before payment to supplier.

FIG. 10B shows only the financial aspects of an exemplary transaction implementing the process flow of FIG. 10A in more detail. On the right hand side, the accounting aspects of an exemplary illustrative transaction for booking a hotel room from an online travel distributor (the vendor) are shown, for the purposes of discussion only and without any wish to be limiting. The payment is a split payment (described in greater detail below), as the hotel wishes to receive Australian dollars (AUD), the purchaser wishes to pay in pounds sterling (GBP) and the financial systems of the vendor operate in US dollars (USD). The “margin” is the mark-up by the vendor. As shown by the below description, these amounts remain constant throughout the transaction, as the multiple exchange rate relationships are fixed through transactional hedging according to the present invention, such that the actual value of the transaction remains fixed in the currencies of all parties throughout the transaction.

As shown, in stage 1 the purchaser requests the item (for example, reserving or booking a hotel room) and makes the payment, preferably by credit card. This payment is booked to accounts receivable by the receiving entity, which may for example be the vendor in the vendor's functional currency. On the right hand side under “Booking”, the example shows a debit to accounts receivable (A/R) and the expected customer deposit credited with amounts calculated both in GBP and US dollars.

In stage 2, payment is made, optionally through settlement of the credit card payment, preferably to the transactional hedging service which more preferably then pays the vendor. In this scenario, the vendor now books the payment to cash and cancels out the accounts receivable. All entries preferably reflect constant amounts in the vendor's functional currency, which are neutralized from the impact of currency rate fluctuations between the time of booking and settlement due to the guarantee of fixed exchange rate relationships throughout the entire transaction flow. On the right hand side, “settlement” shows that payment was received—the “cash” account is debited and the “Accounts Receivable” account credited. As shown, the margin and hotel amounts are still fixed in the vendor's functional currency.

In stage 3, the purchaser uses and/or receives the item (for example by checking out of a hotel room). In this scenario, part of the payment is booked to accounts payable, for example to the supplier, while part is booked as revenue to the vendor (other entries may include various fees, for example payment to the transactional hedging service). On the right hand side, “checkout” revenue is recognized by debiting the “customer deposit” account and crediting “Sales Revenue”. An additional entry debiting the “cost of sales” against “Accounts Payable” is also performed at this stage. Note that amounts are still constant and fixed in the vendor's functional currency.

In stage 4, payment is made to the supplier. Booking entries for “Payment” are shown on the right hand side wherein the amount paid to the supplier is booked to cash against accounts payable. Entries reflect constant amounts in the vendor's functional currency, again neutralized from the impact of currency rate fluctuations between the time of booking and remittance to suppliers due to the guarantee of fixed exchange rate relationships throughout the entire transaction flow. The amounts have been fixed throughout the entire process, even though typically about 40 days pass between booking a hotel room and the use thereof.

Optionally and preferably, such a method is used with a plurality of suppliers having a plurality of different supplier currencies and/or with a plurality of purchasers having a plurality of different purchaser currencies. In any case, fixed exchange rate relationships are maintained throughout the transaction flow, including for the scenario in which split payments are made, for example because the purchaser pays the vendor which then pays part of this payment to the supplier. End-to-end hedging is preferably maintained in any of these scenarios, such that all financial reporting and bookkeeping is preferably maintained in the functional currency of the vendor in an exchange rate neutral manner, such that the actual value in the functional currency of the vendor remains constant.

Furthermore, the present invention supports clean auditable accounting; by outsourcing the currency management to a third party, it simplifies meeting FASB reporting requirements for hedging. All of the transactions are fully auditable as well, further simplifying the reporting requirements.

According to optional features of the present invention, the system supports flexibly determined attributes or parameters which are controlled by trading partners, particularly vendors. Such parameters include, but are not limited to, the selection of supported currencies; treatment for taxes, shipping charges and other costs; support for price drift and mark-ups; risk management strategy for cancelled transactions; price differentiation by currency; periods for rate (price) fixing for each supported currency; rounding method per currency; and margin discounts based on transaction and settlement ceilings, settlement periods, payment installments and chargeback statistics. In addition, another such factor optionally includes the choice of the vendor to adjust the exchange rate with regard to a particular currency, for example in order to promote marketing and sales in a particular country as part of a marketing campaign. These parameters determine the margins and/or transaction fees which are added to the exchange rates quoted to vendors and together with statistics provided by the system, thus allowing risk to be managed by purchasing options contracts based on the expected transaction traffic flow.

With regard to the treatment of canceled payments and/or fraud, the system of the present invention preferably supports two alternative modes of risk management for trading partners. One mode involves the combination of all payment transactions registered by the vendor, (currency rate for return or chargeback transaction based on rate at day of settlement). Another mode involves the hedging/guarantee of all account activity including returns and chargebacks. Depending on the alternative selected by the vendor, positions will either reflect payment transactions only or all transactions in the database.

In addition, optionally the present invention is used for exchanging currencies which are not otherwise freely exchangeable directly. Such currencies can be exchanged if a mechanism exists for purchasing and/or selling an amount of such a currency in a different currency, such that eventually a directly exchangeable currency may be used to complete the transaction. Thus, the present invention is also suitable for currencies of smaller countries and/or countries with exchange restrictions, which might otherwise be difficult to exchange.

Various hedging strategies may optionally be used with the present invention. For example, the previously described dealing room preferably trades standard currency forward and options contracts in the inter-bank market based on forecasted transaction volumes prior to distributing guaranteed exchange rates to vendors to hedge against exposure to currency fluctuation risks.

Netting is preferably automatically performed by the system of the present invention, whereby an exposure to deliver yen to a vendor in Japan could optionally be offset against anticipated receipts in yen from Japanese purchasers, for example.

While the invention has been described with respect to a limited number of embodiments, it will be appreciated that many variations, modifications and other applications of the invention may be made.

What is claimed is:

1. A method for supporting a transaction flow between a purchaser, a vendor and a supplier for an item, the item having a supplier price, the purchaser having a purchaser currency, the vendor having a vendor currency and the supplier having a supplier currency comprising:
providing rate information for converting between the vendor, purchaser and supplier currencies, comprising hedging of the vendor, purchaser and supplier currencies such that the amount to be paid to each of the vendor and supplier is fixed according to the rate information;
calculating a purchaser price for the purchaser according to said rate information and the supplier price;
receiving payment from the purchaser according to said purchaser price;
paying the vendor in the vendor currency; and
paying the supplier in the supplier currency by the vendor;
wherein an exchange rate between each of the vendor, purchaser and supplier currencies is fixed from said calculating said purchaser price, such that a value of the transaction is fixed.

2. The method of claim 1, wherein the vendor receives a vendor fee and wherein said calculating said purchaser price comprises also including said vendor fee.

3. The method of claim 1, wherein there is a delay between said receiving said payment from the purchaser and said paying the supplier, said delay being hedged in said rate information.

4. The method of claim 1, wherein said receiving said payment from the purchaser is performed by a credit card company, such that said paying the vendor is performed by said credit card company in settlement.

5. The method of claim 1, wherein said receiving the payment from the purchaser and said paying the supplier are performed with a time delay of at least one week.

6. The method of claim 5, wherein said time delay is of at least one month.

7. The method of claim 6, wherein the item comprises at least one of a rental car, a hotel room or a seat on an airline flight.

8. The method of claim 7, wherein the item comprises said hotel room.

9. A method for supporting a transaction flow between a purchaser, a vendor and a supplier for an item, the item having a supplier price, the purchaser having a purchaser currency, the vendor having a vendor currency and the supplier having a supplier currency comprising:
providing rate information for converting between the vendor, purchaser and supplier currencies, comprising hedging of the vendor, purchaser and supplier currencies such that the amount to be paid to each of the vendor and supplier is fixed according to the rate information;
calculating a vendor fee for the vendor according to said rate information;
calculating a purchaser price for the purchaser according to said rate information, the vendor fee and the supplier price;
receiving payment from the purchaser according to said purchaser price;
paying the vendor fee in the vendor currency; and
paying the supplier in the supplier currency;
wherein an exchange rate between each of the vendor, purchaser and supplier currencies is fixed from said calculating said purchaser price, such that a value of the transaction is fixed.

10. The method of claim 9, wherein said receiving payment from the purchaser comprises:
receiving said payment by a third party, said third party performing said hedging and calculating said rate information;
such that said paying the vendor fee and paying the supplier are performed separately by said third party.

11. The method of claim 9, wherein said receiving payment from the purchaser comprises:
receiving said payment by a third party;
paying the vendor all of the payment by said third party; and
returning a portion of the payment to said third party by the vendor for paying the supplier.

12. The method of claim 1 1, wherein said receiving the payment from the purchaser and said paying the supplier are performed with a time delay of at least one week.

13. The method of claim 12, wherein said time delay is of at least one month.

14. The method of claim 13, wherein the item comprises at least one of a rental car, a hotel room or a seat on an airline flight.

15. The method of claim 14, wherein the item comprises said hotel room.

16. The method of claim 9, wherein said providing said rate information further comprises:
calculating a value of the transaction according to a functional currency of the vendor;
wherein said value of the transaction remains constant from said calculating said purchase price through said paying the supplier.

17. A method for supporting a transaction for purchasing a product by a purchaser from a vendor, said purchaser using an account having an account number, the product having a price, the currency used by the purchaser being different from a local currency of the vendor, the transaction being processed over an electronic network, the method comprising:
determining a currency of the purchaser through use of an identifying element within data exchanged with said purchaser,
determining an exchange rate of the local currency of the vendor to the currency of the purchaser;
converting the price of the product from the local currency of the vendor to the currency of the purchaser to form a final price according to said exchange rate;
receiving payment from the purchaser for said final price to perform said payment transaction;
converting said payment from the currency of the purchaser to the local currency of the vendor to form a converted payment according to said exchange rate, wherein said exchange rate is guaranteed at a time of transaction, such that the price in the local currency of the vendor is guaranteed and such that the price in the currency of the purchaser is guaranteed, and is hedged; and
paying the vendor with said converted payment wherein at least said receiving said payment from the purchaser, said converting said payment and said paying the vendor are hedged by a transactional hedging system, such that a risk of a change in said exchange rate is hedged.

18. The method of claim 17 wherein said purchaser and vendor communicate through an electronic network.

19. The method of claim 17 wherein said purchaser and vendor are physically in the same location.

20. The method of claim 17 wherein said identifying element comprises leading digits of said account number of said purchaser.

21. The method of claim 20, wherein said account number is associated with a credit card.

22. The method of claim 17 wherein said identifying element is indicative of a geographical region associated with a currency.

23. The method of claim 22 wherein said geographical region is determined through leading digits of a credit card.

24. The method of claim 17 wherein said transactional hedging system manages said risk of said change in said exchange rate and guarantees said exchange rate throughout the transaction.

25. A method for supporting a transaction for purchasing a product by at least one purchaser from a plurality of suppliers through a vendor, the product having a price, the local currency of the purchaser being different from a plurality of local currencies of a plurality of suppliers, the method comprising;
purchasing a plurality of products from a plurality of suppliers by the purchaser through the vendor, each supplier being paid in a separate local currency of the supplier;
determining exchange rates between the currency of the purchaser and a plurality of supplier currencies, each of the exchange rates being hedged and being guaranteed for a separate predetermined period of time;
converting the price of the product from each supplier local currency to the local currency of the purchaser to form a final price according to the exchange rate, such that the purchaser receives information concerning the final price before a payment transaction is performed;
receiving payment from the purchaser for the final price to perform the payment transaction;
converting the payment from the local currency of the purchaser to the local currency of each supplier to form a converted payment according to the exchange rate, wherein the exchange rate is guaranteed at a time of calculating the final price for the purchaser, such that the price in the local currency of each supplier is guaranteed and such that the price in the local currency of the purchaser is guaranteed, and is hedged; and
paying the suppliers with the converted payment.

26. The method of claim 25, wherein the product is comprised of a package of products and services from a plurality of suppliers.

27. The method of claim 25, wherein the vendor does not hold the product in inventory, such that the supplier delivers the product and is due to be paid only upon purchase by the purchaser.

28. The method of claim 27, further comprising:
transferring access to the product by the vendor to the purchaser.

29. The method of claim 28, wherein said transferring access to the product is performed before said paying the suppliers.

30. The method of claim 29, wherein the product is a hotel room.

31. A system for supporting a transaction flow for an item in a plurality of currencies, comprising:
(a) a supplier for supplying the item according to a supplier price, said supplier price being in a supplier currency;
(b) a purchaser for purchasing the item according to a purchaser price, said purchaser price being in a purchaser currency, said purchaser providing payment in said purchaser currency;
(c) a vendor for selling the item to said purchaser, said vendor adding a vendor fee, said vendor fee being in a vendor currency, such that said purchaser price is determined according to said supplier price, said vendor fee and rate information for converting between said supplier currency, said purchaser currency and said vendor currency; and
(d) a transactional hedging service for controlling transaction flow between said supplier, said purchaser and said vendor, said transactional hedging service comprising a hedging system for hedging conversions between said supplier currency, said purchaser currency and said vendor currency to determine said rate information, said transactional hedging service providing said rate information to said vendor and said transactional hedging service dividing said payment from said purchaser between said supplier and said vendor.

32. The system of claim 31 wherein a plurality of suppliers having a plurality of supplier prices and supplier currencies provide the product sold to the purchaser.

33. The system of claim 31, further comprising a tax authority, wherein said transactional hedging service provides a portion of said payment from said purchaser to said tax authority.

34. A method for supporting a transaction flow between a purchaser, a vendor and a supplier for an item, the item having a supplier price, the purchaser having a purchaser currency, the vendor having a vendor currency and the supplier having a supplier currency, the method comprising:
providing rate information for converting between the vendor, purchaser and supplier currencies, said information including hedging of an exchange rate between the vendor, purchaser and supplier currencies such that the amount to be paid to each of the vendor and supplier is fixed according to the rate information and such that said exchange rate for the amount to be paid to each of the vendor and supplier and the amount to be paid by the purchaser is hedged to guarantee a future exchange of currency using said exchange rate;
calculating a vendor fee for the vendor according to said rate information;
calculating a purchaser price for the purchaser according to said rate information, the vendor fee and the supplier price;
receiving payment from the purchaser according to said purchaser price by a transactional hedging service;
paying said payment to the vendor in the vendor currency by said transactional hedging service, including the vendor fee;
paying at least the supplier price to said transactional hedging service by the vendor after a time delay in the vendor currency; and
paying the supplier in the supplier currency by said transactional hedging service.

35. The method of claim 34, wherein said purchaser price is guaranteed for the purchaser for a fixed period of time.

36. The method of claim 34, wherein the item comprises at least one of a hotel, a rental car and an airline flight.

37. The method of claim 34, wherein said purchase price further comprises a fee for said transactional hedging service.

38. The method of claim 37, wherein said rate information comprises a spot rate, said vendor fee and said transactional hedging service fee for determining said purchase price.

39. The method of claim 34, wherein said hedging is performed with at least one of an option or a forward contract.

40. The method of claim 34, wherein the purchaser, the vendor, the supplier and said transactional hedging service communicate on-line.

41. The method of claim 40, wherein said transactional hedging service controls the transaction flow between the purchaser, the vendor and the supplier.

42. The method of claim 41, wherein the transaction flow is automated.

43. A system for supporting a transaction flow for an item in a plurality of currencies, comprising:
(a) a supplier for supplying the item according to a supplier price, said supplier price being in a supplier currency;
(b) a purchaser for purchasing the item according to a purchaser price, said purchaser price being in a purchaser currency, said purchaser providing payment in said purchaser currency;
(c) a vendor for selling the item to said purchaser, said vendor adding a vendor fee, said vendor fee being in a vendor currency, such that said purchaser price is determined according to said supplier price, said vendor fee and rate information for converting between said supplier currency, said purchaser currency and said vendor currency, said vendor comprising a vendor accounting system; and
(d) a transactional hedging service for controlling the transaction flow between said supplier, said purchaser and said vendor, said transactional hedging service comprising a hedging system for hedging conversions between said supplier currency, said purchaser currency and said vendor currency to determine said rate information, said transactional hedging service providing said rate information to said vendor and said transactional hedging service dividing said payment from said purchaser between said supplier and said vendor, wherein said transactional hedging service provides information about said transactional flow to said vendor accounting system and wherein a value of said transactional flow remains constant in said vendor currency.

44. A system for supporting a transaction flow for a plurality of items in a plurality of currencies, comprising:
(a) a plurality of suppliers for supplying the item according to a plurality of supplier prices, each supplier price being in a supplier currency, each supplier currency being different for each supplier;
(b) a purchaser for purchasing the plurality of items according to a plurality of purchaser prices, said purchaser prices being in a purchaser currency, said purchaser providing payment in said purchaser currency, said purchaser currency being different from at least two of said supplier currencies;
(c) a vendor for selling the item to said purchaser, said vendor adding a vendor fee, said vendor fee being in a vendor currency, such that said purchaser prices are determined according to said supplier prices, said vendor fee and rate information for converting between said supplier currencies, said purchaser currency and said vendor currency, said vendor comprising a vendor accounting system; and
(d) a transactional hedging service for controlling the transaction flow between said suppliers, said purchaser and said vendor, said transactional hedging service comprising a hedging system for hedging conversions between said supplier currencies, said purchaser currency and said vendor currency, said transactional hedging service providing said rate information to said vendor and said transactional hedging service dividing said payment from said purchaser between said suppliers and said vendor, wherein said transactional hedging service provides information about said transactional flow to said vendor accounting system and wherein a value of said transactional flow remains constant in said vendor currency.

45. A method for supporting a transaction flow between a purchaser, a vendor and a supplier for an item, the item having a supplier price, the purchaser having a purchaser currency, the vendor having a vendor currency and the supplier having a supplier currency, the method comprising:
providing rate information for converting between the vendor, purchaser and supplier currencies, said information including hedging of an exchange rate between the vendor, purchaser and supplier currencies such that the amount to be paid to each of the vendor and supplier is fixed according to the rate information and such that said exchange rate for the amount to be paid to each of the vendor and supplier and the amount to be paid by the purchaser is hedged to guarantee a future exchange of currency using said exchange rate;
calculating a vendor fee for the vendor according to said rate information;
calculating a purchaser price for the purchaser according to said rate information, the vendor fee and the supplier price;
receiving payment from the purchaser according to said purchaser price by a transactional hedging service;
paying said payment to the vendor in the vendor currency by said transactional hedging service, including the vendor fee;
paying at least the supplier price to said transactional hedging service by the vendor after a time delay in the vendor currency; and
paying the supplier in the supplier currency by said transactional hedging service;
wherein the transaction is reversed before any of said paying the vendor, said transactional hedging service or the supplier, such that at least one of said paying the vendor, said transactional hedging service or the supplier is not performed and wherein a reversal of the transaction is hedged such that the purchaser receives a complete amount of said payment in said purchaser currency.

46. The method of claim 45, wherein said reversal comprises a refund, a chargeback or a cancellation of a credit card payment transaction.
